(19) United States
(12) Patent Application Publication
(10) Pub. No.: US 2021/0099431 A1
(43) Pub. Date: Apr. 1, 2021

(54) SYNTHETIC IDENTITY AND NETWORK EGRESS FOR USER PRIVACY

(71) Applicant: Avast Software s.r.o., Prague (CZ)

(72) Inventors: Armin Wasicek, El Cerrito, CA (US); Juyong Do, Cupertino, CA (US); Rajarshi Gupta, Los Altos, CA (US)

(73) Assignee: Avast Software s.r.o., Prague (CZ)

(21) Appl. No.: 16/918,851

(22) Filed: Jul. 1, 2020

Related U.S. Application Data
(63) Continuation-in-part of application No. 16/586,734, filed on Sep. 27, 2019.

(51) Int. Cl. H04L 29/06; G06N 3/04; G06N 3/08

(52) U.S. Cl. CPC H04L 63/0428; H04L 63/0272; G06N 3/08; G06N 3/04

(57) ABSTRACT

A method of generating a synthetic user profile to protect the user's privacy includes generating a synthetic profile comprising a plurality of profile elements and selecting a network egress point for use with the synthetic profile. The synthetic profile elements and egress point have a consistent geographic location, or the synthetic profile elements are consistent with other external information.

### CLAIM OF PRIORITY

This application is a continuation-in-part of application Ser. No. 16/586,734, filed Sep. 27, 2019, titled “Privacy Personas Using Synthetic Personally Identifiable Information.” This application is hereby incorporated by reference by way of example and does not limit the scope of the invention described herein.

### FIELD

The invention relates generally to computer networks, and more specifically to using synthetic user identity and network egress for user privacy.

### BACKGROUND

Computers are valuable tools in large part for their ability to communicate with other computer systems and exchange information over computer networks. Networks typically comprise an interconnected group of computers, linked by wire, fiber optic, radio, or other data transmission means, to provide the computers with the ability to transfer information from computer to computer. The Internet is perhaps the best-known computer network and enables billions of people to access billions of other computers such as by viewing web pages, sending e-mail, engaging in e-commerce, or by performing other computer-to-computer communication.

But, because the size of the Internet is so large and Internet users are so diverse in their interests, it is not uncommon for malicious users to attempt to communicate with other users' computers in a manner that poses a danger to the other users. For example, a hacker may attempt to log in to a corporate computer to steal, delete, or change information. Computer viruses or Trojan horse programs may be distributed to other computers or unknowingly downloaded such as through email, download links, or srnartphone apps, and used for purposes such as to steal personally identifiable information or to establish botnets that perform undesirable tasks such as sending spam emails or mining cryptocurrency. Further, legitimate computer users within an organization such as a corporation may on occasion attempt to perform unauthorized network communications, such as running file sharing programs, copying corporate secrets, or misusing personal information of users or Customers.

Online user activity such as banking, social media, and other network activity may be intercepted, monitored, or faked by a variety of software, computer systems, or network devices, enabling rogue actors to steal identities or personal information. For example, a user's name, credit card information, address, and other such information are often used in conducting legitimate online commerce, but can be stolen and illegally used for everything from unauthorized purchases to stealing the user's identity. Further, many websites such as social media sites attempt to verify the authenticity of user accounts by asking for increasing amounts of Personally Identifiable Information (PII), which is often subject to data breaches by hackers and subject to misuse such as by selling such data to third parties for uses that do not benefit the users.

For these and other reasons, some users wish to engage in online activity without divulging their true Personally Identifiable Information or PII to many websites or online services. It is therefore desirable to provide a mechanism for users to interact with websites and other online services that preserves the privacy of the user's Personally Identifiable Information.

### SUMMARY

One example embodiment of the invention comprises a method of protecting a user's privacy by providing a synthetic user profile. A synthetic profile comprising a plurality of profile elements is generated, and a network egress point for use with the synthetic profile is selected such that the synthetic profile elements and egress point have a consistent geographic location. In a further example, a user selects a geographic region for the network egress point. In some examples, the synthetic profile is generated by a machine learning system such as a neural network that is trained using real user profiles. The synthetic profile is saved for re-use in some examples, facilitating use of the synthetic profile for ongoing applications such as social media, online gaming, and the like.

In another example, a synthetic user profile is provided by identifying external information for use with the synthetic profile, and generating a synthetic profile comprising plurality of profile elements such that the plurality of synthetic profile elements and the external information are consistent with one another. In a more detailed example, the external information is a geographic location of a selected network egress point remote from a user of the synthetic profile, and the geographic location is consistent with the synthetic profile. In other examples, the external information comprises other environmental information external to the synthetic profile.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a network environment in which a synthetic identity and remote network egress point are used to preserve user privacy, consistent with an example embodiment.

FIG. 2 shows interaction between a browser and VPN on a client device, consistent with an example embodiment

FIG. 3 is a flowchart of a method of using a synthetic profile and remote network egress point geographically consistent with the synthetic profile to preserve user privacy, consistent with an example embodiment.

FIG. 4 is a computerized system comprising a user privacy module operable to generate a synthetic user profile and select a network egress point consistent with the synthetic profile, consistent with an example embodiment

### DETAILED DESCRIPTION

In the following detailed description of example embodiments, reference is made to specific example embodiments by way of drawings and illustrations. These examples are described in sufficient detail to enable those skilled in the art to practice what is described and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the value of the information they store, the data such as passwords and financial accounts they capture, and even their computing power becomes a tempting target for criminals. Hackers regularly attempt to log in to a corporate computer to steal, delete, or change information, or to encrypt the information and hold it for ransom via “ransomware.” Smartphone apps, Microsoft Word documents containing macros, Java applets, and other such common documents are all frequently infected with malware of various types, and users rely on tools such as antivirus software or other malware protection tools to protect their computerized devices from harm. Malicious users often attempt to steal user credentials to popular online websites or services by creating fake sites pretending to be the popular websites, or by stealing personal information stored in legitimate sites such as online commerce or social media websites.

Certain online user activities including banking, social media, and e-commerce are particular targets of hackers wishing to steal Personally Identifiable Information (often simply called PII), as such information is often used to verify the identity and legitimacy of users. But, such Personally Identifiable Information (PII) may be intercepted, monitored, or stolen by a variety of software, computer systems, or network devices, enabling rogue actors to steal personal information or identities.

For example, a user's name, credit card information, address, and other such information are often used in conducting legitimate online commerce, but can be stolen and illegally used for everything from unauthorized purchases to stealing the user's identity. Further, many websites such as social media sites attempt to verify that new users signing up are real people rather than fake accounts by asking for increasing amounts of Personally Identifiable Information (PII), which is stored on the servers as part of a user profile. This stored information is then often subject to data breaches by hackers, and subject to misuse such as by selling such data to third parties for uses that do not benefit the users. In one such example, personal user information stored by Facebook was sold to Cambridge Analytica for use in targeting political advertising during the 2016 US presidential election.

But, because social media and other websites and services often require such information be provided to use the services they provide, users typically have little choice but to provide such Personally Identifiable Information (PII). Some users attempt to provide false or inaccurate Personally Identifiable Information to avoid misuse or unauthorized disclosure of their information, but websites and other online services are becoming increasingly sophisticated at identifying user profiles with inconsistent or atypical user information and will typically reject such attempts. Further, even if a user is successful in creating a fictitious user profile, the user may have difficulty remembering or managing all the information associated with the fictitious user, making use of such a fake user profile difficult.

Some examples described herein therefore seek to preserve user privacy by providing a synthetic user profile containing false or synthesized user information that is difficult to distinguish from an authentic user profile, along with a network egress point or public network entry point that is consistent with the synthetic user profile. For example, a synthetic user profile of a 38 year old man who lives in Texas may include social media accounts with friends from Texas and an interest in Texas sports teams and other events, Google or Yelp accounts with user reviews of businesses from Texas, and e-commerce accounts such as an Amazon account with a Texas shipping address. The synthetic user account further includes one or more network egress points having a Texas-associated IP address, such as Virtual Private Network tunnels to Texas-based servers.

In a more detailed example, a user wishing to engage with online services while preserving his identity establishes an account with a privacy service provider website using his real identity, and initiates creation of a synthetic profile. The synthetic profile may meet certain criteria that are similar to the real user, such as gender, age, or certain interests, while other information such as geographic location, social security number, phone number, and address are synthesized to preserve the user's privacy. The synthetic profile in a further example includes a home address of the user, which is used to establish a network egress point for use of the user profile, which is typically a Virtual Private Network (VPN) server located in the same geographic region as the user's synthetic profile home address. In other examples, the user employs other mechanisms such as an app and/or custom VPN software to create a synthetic profile and connect with a remote egress point consistent with the synthetic profile's geographic location.

In operation, the user initiates creation of a synthetic user profile such as by employing an app, browser plugin, remote server, or similar tool configured to generate a synthetic profile. In one such example, the user logs on to a privacy service provider's service such as by logging on to the provider's website, using a browser plugin or smartphone app, or other such means to initiate an online session using the synthetic user profile. Once a session with the privacy service provider has been established, communication between the user and online services conducted through the privacy service provider's service will use the user's synthetic identity and a network egress point consistent with the synthetic identity's associated geographic address. The privacy service provider's service thereby enables the user to interact with various online services such as social media, e-commerce, or other sites or services using the synthetic profile associated with the user, thereby preserving the user's real identity when interacting with various online services. When the user is done, the user doses the privacy service provider's website, app, browser, or other mechanism, and is able to interact with online services using his real identity.

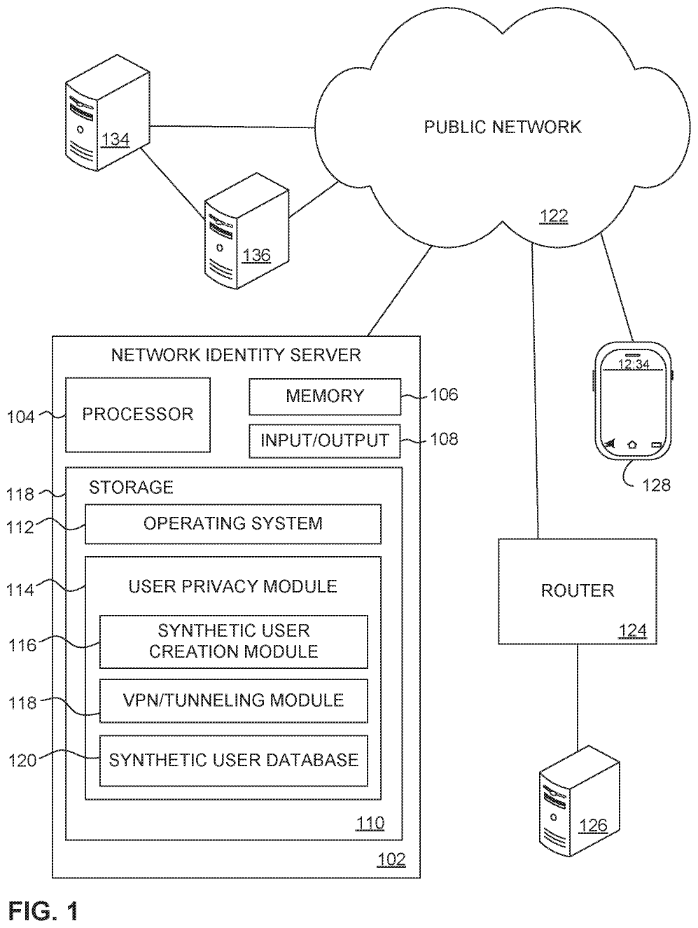

FIG. 1 shows a network environment in which a synthetic identity and remote network egress point are used to preserve user privacy, consistent with an example embodiment. Here, a network identity server 102 comprises a processor 104, memory 106, input/output elements 108, and storage 110. Storage 110 includes an operating system 112, and user privacy module 114 that is operable to provide a synthetic user profile and remote network egress point for users wishing to use a synthetic network profile, such as to protect the privacy of their real identity. The user privacy module 114 further comprises a synthetic user creation module 116 operable to create a synthetic user profile comprising information for a user who is not real, but that closely resembles the profile of real users in a way that it is difficult to distinguish from the profile of a real user. A Virtual Private Network (VPN)/tunneling module 118 is operable to create a secure connection to a remote VPN server such that traffic from a user appears to originate from the remote VPN server on a public network such as the Internet, such as by sending connection or authentication information of a remote VPN server in a geographic location consistent with a user's synthetic user profile to a user device. A synthetic user database 120 stores created synthetic user profiles and their associated real user owners, including information such as geographic location of the synthetic user for use in selecting a remote VPN server to use in conjunction with the synthetic user profile.

The network identity server 102 is coupled to a public network 122. A router 124 connects the public network to end user devices such as personal computer 126 and to devices such as smartphone 128, which may be coupled via a router 124 or directly via other mechanisms such as a cellular data network coupled to the Internet. These devices may communicate with remote servers 134 via the public network 122, including conducting transactions involving disclosing user identity such as engaging in e-commerce, social media, or other such transactions. The remote server 134 in this example is also connected to the public network 122 via the remote VPN server 136, which can be used to create a network egress point such that communication between end user devices such as computer 126 and smartphone 128 appear to the server 134 to originate from remote VPN server 136.

Although the network identity server 102 in this example includes functionality such as generating and storing synthetic user profiles and a module to assist in establishing a VPN tunnel connection between a user device such as computer 126 or smartphone 128 and a remote VPN server 136, some or all of these functions in other examples will be embodied in other devices, such as within the user devices. A network identity server provides the advantage of centralized storage of synthetic users in database 120, along with an up-to date record of VPN servers such as 136 that are available for network egress points consistent with a synthetic profile's geographic location. Incorporation of at least some of these features into end user devices provides other advantages, such as local generation and/or storage of one or more synthetic user profiles associated with the user further enhancing the user's privacy.

In operation, an end user such as a user of computer system 126 or smartphone 128 wishes to create a synthetic user profile to preserve the privacy of their true identity. The user may wish to engage with social media, such as various events, businesses, and groups without revealing their true identity, or to participate in a game, e-commerce, or execute a mobile app or other software that requires use of user information without revealing their true identity. Hiding their real identity may shield users from potential identity theft, or from loss of financial information such as credit card numbers or bank accounts. Similarly, protecting users' real identities can protect them from harassment from other social media or online gaming participants, and can prevent online advertisers and other tracking services from using the user's activity to create a robust profile of the users' interests, activities, travels, and the like that may be construed as an invasion of the user's privacy or misused by the profiler.

The user of a device such as computer system 126 or smartphone 128 access the network identity server 102, such as by visiting a web page, installing and configuring a browser plugin, installing and executing a smartphone app, or through another such mechanism. The user uses his real identity to access the network identity server, such as using an email address or phone number along with a password, to identify himself to the network identity server and create a synthetic user profile associated with his true identity or to retrieve and use previously created synthetic profiles. The synthetic user creation module 116 creates one or more synthetic user profiles for the user, storing the created synthetic user profile information in a synthetic user database 120 such that it is associated with the user. The synthetic user profile includes in a further example a geographic location of the user, which is used in combination with the VPN/tunneling module 118 to select a remote VPN server as a network egress point so that network traffic from the user using the synthetic user profile appears to come form a geographic location near the geographic location associated with the synthetic user profile.

Once a synthetic user profile is generated for the user, the user is able to selectively employ the synthetic user profile instead of their own real user identity to perform various online activities. Having one or more durable synthetic user profile that can be reused enables the user in some examples to maintain a social media profile, participate in ongoing games, and to make returns, re-orders, scheduled shipments, and other such transactions in e-commerce, all of which would be difficult if synthetic profile information were not stored for reuse.

In one such example, the user employs a browser extension or plugin on end user computer 126 to selectively access network identity server 102 to retrieve a stored synthetic profile associated with the user's account. The browser extension or plugin in some further examples retrieves the user's synthetic profile information from the network identity server 102's synthetic user database and stores and employs the synthetic user profile information locally such as to fill out forms, enter login credentials, and perform other such functions using the synthetic user profile information, but in other examples routes some or all communication between the user and other public network devices through the network identity server 102 on its way to servers such as 134.

In another example, the browser extension on end user's computer system 126 stores the synthetic user profile locally, and uses the network identity server 102 for some, all, or none of the tasks related to generating a synthetic user profile, storing the synthetic user profile, and selecting an available remote VPN server geographically local to the synthetic user profile's geographic location. In some such embodiments synthetic user profile information will still be uploaded to the network identity server and associated with the user's true identity so that the user can access the synthetic user profile from other devices such as smartphone 128 and can use the synthetic user profile across multiple devices.

The connection between an end user device such as computer 126 or smartphone 128 and a server 134 through a remote Virtual Private Network (VPN) server 136 that is geographically near a geographic location associated with the user's synthetic profile is established in some examples via the network identity server 102, such as by retrieving a suitable and available remote VPN server address from the network identity server, or authenticating between the end user device and remote VPN server via the network identity server. In other examples, the connection between end user devices and the remote VPN server is established directly between software or hardware on the end user device, such as a VPN client, and a suitable remote VPN server. End user device hardware and software that may be employed to establish the VPN connection includes in various embodiments special VPN client software, a browser extension or plugin, an app, an operating system feature or extension, a router supporting VPN communication, and other such hardware and/or software elements.

Once a synthetic profile is created for the user and a VPN connection is established between the user's device and the remote VPN server, the user is able to perform various functions using the synthetic profile while interacting with other servers 134, such as web servers or other online services. In one such example, the synthetic user profile includes a set of cookies that are associated with the synthetic profile and that may be provided to a requesting server 134 such as when a web page is loaded. In another example, synthetic profile login credentials for a web page, online game, or other online service are provided to the server 134 via the browser plugin or extension. In a further example, logins for popular website such as Facebook and Google are created and stored so that they are available for authentication to third-party websites, such as using OAuth authentication. Some synthetic profile examples store user information such as an address, phone number, single-use or limited funds credit card number, and/or other such information that can be used to fill out forms consistent with the synthetic profile's identity.

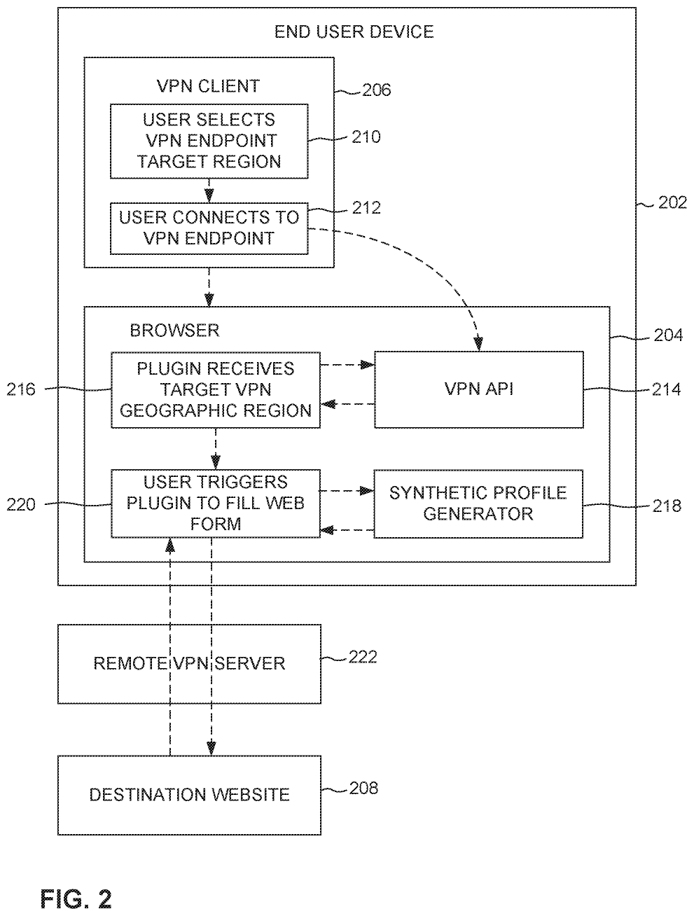

FIG. 2 shows interaction between a browser and VPN on a client device, consistent with an example embodiment. Here, an end user device 202 such as a personal computer, smartphone, tablet, or the like, includes a web browser 204 with a synthetic profile plugin or extension and a VPN client 206. The end user device's user wishes to communicate with destination website 208 without divulging his true identity, and initiates a synthetic profile communication session by generating a synthetic profile at synthetic profile generator 210. In this example, the user uses the VPN client 206, such as Avast's SecureLine VPN software, to select a target geographic region as shown at 210. The VPN client connects to a VPN endpoint in the selected target geographic region at 212, and forwards the target geographic region and/or connected VPN geographic location to the browser's synthetic profile plugin or extension.

The browser receives the target VPN geographic region in a VPN API at 214, and passes the geographic region to the browser's synthetic profile plugin or extension at 216. In an alternate example, a query from the browser's synthetic profile plugin to the VPN API for a target geographic region triggers the VPN selection process in the VPN client 206. In another example, triggering the synthetic profile plugin or extension to fill a web form as shown at 220 initiates generation of a synthetic user profile at 218 and selection of a remote VPN server 222. In some such examples, a web page or other content from the destination website 208 is retrieved in the browser 204 before the user triggers the plugin 220, ensuring that the synthetic profile generator 208 will generate all synthetic profile elements requested by the web page (such as synthetic profile information needed to complete a form). The user may supplement synthetic profile information the synthetic profile generator 218 is not able to generate, such as where the synthetic profile generator does not understand what content may be appropriate for a particular field on the web page or form.

Once the synthetic profile generator 218 has generated a synthetic user profile and the VPN client has connected to a remote VPN server 222 in a geographic location consistent with the synthetic user profile's address or geographic location, the browser 204 can load web pages (if not already loaded) from the destination website 208 such as web pages, login screens, forms, and other such data. The browser's synthetic profile plugin or extension is further operable to use the user's synthetic profile to provide information back to the destination website 208 such as login credentials, completed forms, cookies, and other data derived from the user's synthetic profile. Because the end user device 202 is communicating via the remote VPN server 222 as a network egress point, the user's end user device network traffic appears to the destination website 208 to be coming from the remote VPN server 222. This reduces the chances of the destination website rejecting any synthetic user profile information received from the end user device because the information came from a network location inconsistent with the synthetic user profile's geographic area or address.

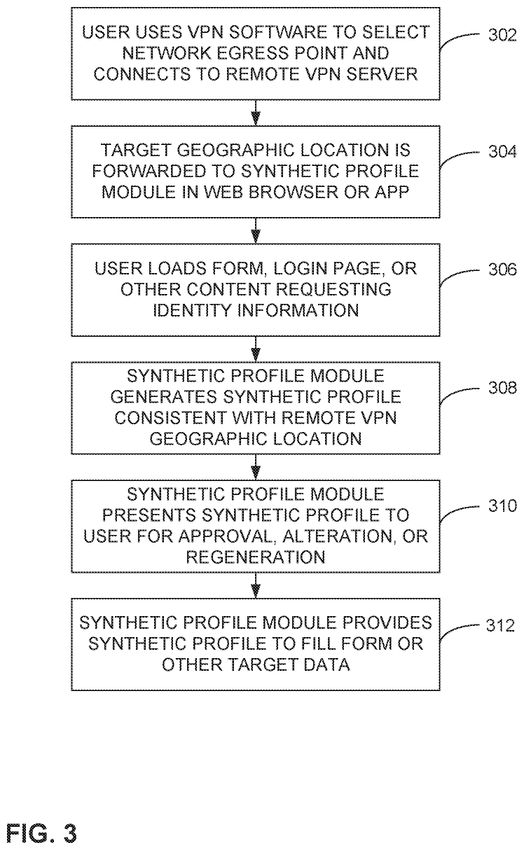

FIG. 3 is a flowchart of a method of using a synthetic profile and remote network egress point geographically consistent with the synthetic profile to preserve user privacy, consistent with an example embodiment. At 302, a user desiring to preserve the privacy of personally identifiable information (PII) or otherwise wishing to remain anonymous while conducting online interactions uses VPN software to select a desired geographic area for a network egress point, such as by selecting a remote VPN server having a particular geographic location or specifying a geographic location in searching for a suitable remote VPN server. The VPN software in some examples resides on the user's device, while in other examples is at least in part hosted remotely by a server such as a network service provider or security software provider.

The target geographic location or the location of the selected remote VPN server is forwarded to a synthetic profile module in a web browser at 304. In some examples the synthetic profile module is a plugin or extension, while in other examples it is part of a custom or special purpose browser provided for protecting user identity information. On other devices such as smartphones, the synthetic profile module takes other forms such as a smartphone app, an autocomplete or password management service, or other such embodiment.

At 306, the user loads a web page, form, login screen, or other network content requesting identity information from the user. In some examples, the synthetic profile module captures the requested identity information ensuring that appropriate information to complete the request is generated or input as part of creating the synthetic profile. The synthetic profile module generates a synthetic profile at 308, including in some examples at least the identity information requested by the network content at 306, such that the synthetic profile's geographic information such as address, phone number, and the like are consistent with the geographic location of the network egress point selected at 302.

The synthetic profile module then presents the synthetic profile to the user for approval, enabling the user in various examples to approve or reject the synthetic profile, to regenerate another synthetic profile, to modify the generated synthetic profile, or otherwise modify, approve, or reject the synthetic profile. Once the synthetic profile is approved, the synthetic profile module uses the synthetic profile data to fill the form, login page, or other content requesting identity information at 306 using the remote VPN server as a network egress point.

The synthetic profile is desirably generated in a manner that is sufficiently sophisticated to resemble actual user profiles, such that any user profile verification or integrity check performed by the web server or other network service will recognize the synthetic profile as legitimate. This is achieved in some examples by ensuring that the synthetic profile meets certain criteria, such as having a geographic location, phone number, and other such information consistent with the selected remote VPN server's location. The attributes of the identity should also fit, both singly and with each other. A person named “Window” for example, is implausible at any age, while some common names like “Amanda” or “Dustin” are significantly more popular for people born in the 1980 s than people born before or after that decade. Similarly, a person named “Leif” may be reasonably plausible for a synthetic profile based in Minnesota, but less plausible in Alabama. Leif is also distinctly a male name, and is implausible for females anywhere.

These examples show how careful selection of synthetic profile data that is both plausible when viewed attribute by attribute and is plausible when the attributes are considered in view of each other will result in a synthetic profile that is resilient against authenticity checks and verification.

In a more sophisticated example, one or more synthetic profiles are maintained so that the profile can be reused for purposes where repeat use of the same profile is desired, such as social media or online gaming. For such profiles, it may be desirable to further enhance the synthetic profile with additional actions that make the profile appear authentic, such as creating a Facebook or Google account for the synthetic profile that can be used to verify the synthetic profile by logging in or receiving email, or such as capturing an available phone number for use with the synthetic profile so that the phone number can be used to receive and process verification codes sometimes used in signup or verification processes. As with the remote VPN server used as the network egress point, the phone number used is desirably consistent with the geographic region of the rest of the profile, including the correct area code and an appropriate central office code (the three numbers following the area code for U.S. phone numbers) for the geographic area.

Some information used for user profile validation is external information, which is information that the validator uses from the environment rather than from submitted profile data. Changes of the environment in which the user operates, such as the user's IP address, are considered external information while information that a synthetic profile generator submits, such as a user's name, are not. For profile validators that look at traditional profile information such as user names as well as external information such as a user's current IP address, a mechanism for providing the desired external information is necessary. External information related to the context of a user's interaction with a remote server, such as the IP address from which the user is interacting with the remote server, is both readily available to the remote server and useful in determining whether this external information is consistent with the profile information the user provides. Use of a remote VPN server as a network egress point in a geographic region consistent with a generated synthetic user profile addresses one such piece of external information by ensuring that the observed IP address of the user is the IP address of the remote VPN server, which is selected to be in the correct geographic region for the synthetic profile.

By considering correct syntax for requested data (e.g., a zip code in the United States is five numerical digits), statistics (e.g. a name that is plausible for someone's gender and age or a phone number consistent with an address), and external information such as the user's apparent Internet Protocol or IP address being consistent with the generated portions of the synthetic profile, the synthetic profile will be very difficult to distinguish from a rea person's profile.

Determination of whether a profile is likely real or is likely fake is performed in some examples by using artificial intelligence techniques, such as neural networks or other machine learning models, to evaluate a large number of known real user profiles and known fake profiles as training data. Neural As additional fake profiles are found, or evaluated profiles are falsely determined to be fake, such profiles can be added to the training data or other machine learning mechanisms to improve the performance of the artificial intelligence method being employed.

The artificial intelligence method will desirably learn to use both sematic or statistical evaluation of individual profile elements, as well as the relationship between profile elements and consistency of user profile information with external information such as a geographic location associated with an IP address of the user. For synthetic profile examples, the geographic region associated with the IP address can be effectively faked by using a remote VPN server in a selected geographic region as a network egress point.

A similar artificial intelligence system may be employed by the synthetic profile module in some examples to generate a synthetic profile having data fields that are internally consistent with each other and that are consistent with external information such as the geographic location of a user IP address. Deep learning neural networks, recurrent neural networks, convolutional neural networks, an adversarial neural network, or the like. In some embodiments, input and/or output words will be converted to vectors, such as one-hot encoding of the input data word. In a further example, a separate network may be employed for different data elements within the synthetic profile generator, such as a last name generator that generates a name based on factors such as a selected geographic location, and a first name generator that receives the synthetic last name and geographic location to generate a first name that is ethnically and regionally consistent with the synthesized first name.

The examples presented here illustrate how use of a synthetic profile can help protect a user's privacy and Personally Identifiable Information (PII). Use of a remote VPN server having a geographic location consistent with a synthetic profile as a network egress point for client communication using the synthetic profile can help the synthetic profile be resilient against screening tools that evaluate profiles for fakes by making the client communication appear to come from the geographic location of the remote VPN server. External information other than an IP address of the network egress point and an associated geographic location are used in other examples to enhance the robustness of the synthetic profile against screening or verification processes. Although the synthetic profile module, VPN, and other elements shown in the examples here are shown as implemented on a client computer or a network server, a variety of other computerized systems may be used in other examples.

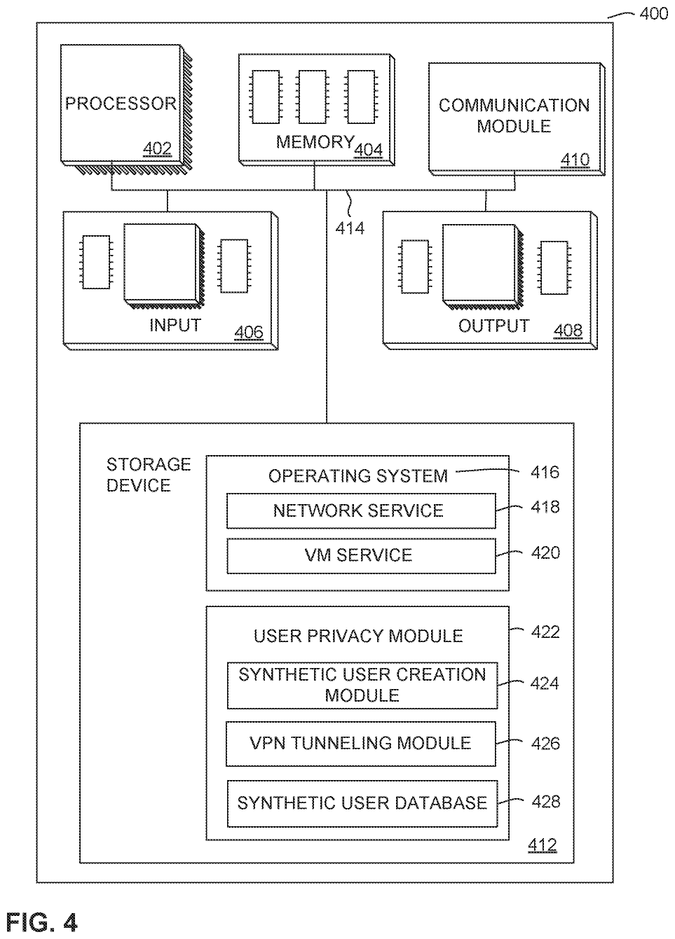

FIG. 4 is a computerized system comprising a user privacy module operable to generate a synthetic user profile and select a network egress point consistent with the synthetic profile, consistent with an example embodiment. FIG. 4 illustrates only one particular example of computing device 400, and other computing devices 400 may be used in other embodiments. Although computing device 400 is shown as a standalone computing device, computing device 400 may be any component or system that includes one or more processors or another suitable computing environment for executing software instructions in other examples, and need not include all of the elements shown here.

As shown in the specific example of FIG. 4, computing device 400 includes one or more processors 402, memory 404, one or more input devices 406, one or more output devices 408, one or more communication modules 410, and one or more storage devices 412. Computing device 400, in one example, further includes an operating system 416 executable by computing device 400. The operating system includes in various examples services such as a network service 418 and a virtual machine service 420 such as a virtual server. One or more applications, such as user privacy module 422 are also stored on storage device 412, and are executable by computing device 400.

Each of components 402, 1004, 406, 408, 410, and 412 may be interconnected (physically, communicatively, and/or operatively) for inter-component communications, such as via one or more communications channels 414. In some examples, communication channels 414 include a system bus, network connection, inter-processor communication network, or any other channel for communicating data. Applications such as malware evaluation module 422 and operating system 416 may also communicate information with one another as well as with other components in computing device 400.

Processors 402, in one example, are configured to implement functionality and/or process instructions for execution within computing device 400. For example, processors 402 may be capable of processing instructions stored in storage device 412 or memory 404. Examples of processors 402 include any one or more of a microprocessor, a controller, a digital signal processor (DSP), an application specific integrated circuit (ASIC), a field-programmable gate array (FPGA), or similar discrete or integrated logic circuitry.

One or more storage devices 412 may be configured to store information within computing device 400 during operation. Storage device 412, in some examples, is known as a computer-readable storage medium. In some examples, storage device 412 comprises temporary memory, meaning that a primary purpose of storage device 412 is not long-term storage. Storage device 412 in some examples is a volatile memory, meaning that storage device 412 does not maintain stored contents when computing device 400 is turned off. In other examples, data is loaded from storage device 412 into memory 404 during operation. Examples of volatile memories include random access memories (RAM), dynamic random access memories (DRAM), static random access memories (SRAM), and other forms of volatile memories known in the art. In some examples, storage device 1012 is used to store program instructions for execution by processors 402. Storage device 412 and memory 404, in various examples, are used by software or applications running on computing device 400 such as user privacy module 422 to temporarily store information during program execution.

Storage device 412, in some examples, includes one or more computer-readable storage media that may be configured to store larger amounts of information than volatile memory. Storage device 412 may further be configured for long-term storage of information. In some examples, storage devices 412 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 400, in some examples, also includes one or more communication modules 410. Computing device 400 in one example uses communication module 410 to communicate with external devices via one or more networks, such as one or more wireless networks. Communication module 410 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 400 uses communication module 410 to wirelessly communicate with an external device such as via public network 122 of FIG. 1.

Computing device 400 also includes in one example one or more input devices 406. Input device 406, in some examples, is configured to receive input from a user through tactile, audio, or video input. Examples of input device 406 include a touchscreen display, a mouse, a keyboard, a voice responsive system, video camera, microphone or any other type of device for detecting input from a user.

One or more output devices 408 may also be included in computing device 400. Output device 408, in some examples, is configured to provide output to a user using tactile, audio, or video stimuli. Output device 408, in one example, includes a display, a sound card, a video graphics adapter card, or any other type of device for converting a signal into an appropriate form understandable to humans or machines. Additional examples of output device 408 include a speaker, a light-emitting diode (LED) display, a liquid crystal display (LCD), or any other type of device that can generate output to a user.

Computing device 400 may include operating system 416. Operating system 416, in some examples, controls the operation of components of computing device 400, and provides an interface from various applications such as network protection module 422 to components of computing device 400. For example, operating system 416, in one example, facilitates the communication of various applications such as user privacy module 422 with processors 402, communication unit 410, storage device 412, input device 406, and output device 408. Applications such as user privacy module 422 may include program instructions and/or data that are executable by computing device 400. As one example, user privacy module 422 executes a synthetic user creation module 424 program instruction sequence that generates a synthetic user profile, such as by employing a neural network trained with real user profiles. A VPN tunneling module 426 enables selection of a VPN server as a network egress point that is consistent with geographic location information in the synthetic user profile, making the synthetic user profile more robust against being detected as suspicious or fake. A synthetic user profile database 428 stores user profiles and in a further example associated remote VPN servers so that a user can re-use a synthetic profile when desired. These and other program instructions or modules may include instructions that cause computing device 400 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of providing a synthetic user profile, comprising:
generating a synthetic profile comprising a plurality of profile elements; and
selecting a network egress point for use with the synthetic profile;
wherein the synthetic profile elements and egress point have a consistent geographic location.

2. The method of providing a synthetic user profile of claim 1, wherein selecting a network egress point occurs before generating the synthetic profile, such that one or more of the plurality of profile elements are generated to be consistent with the network egress point.

3. The method of providing a synthetic user profile of claim 1, further comprising receiving input from a user regarding a desired geographic area for selection of the network egress point, and wherein selecting the network egress point is based at least in part on the input desired geographic location.

4. The method of providing a synthetic user profile of claim 1, wherein generating the synthetic profile occurs before selecting a network egress point, such that the network egress point is selected to be consistent with one or more of the plurality of profile elements.

5. The method of providing a synthetic user profile of claim 1, wherein a consistent geographic location comprises a network egress point and profile elements within 5, 10, 20, 50, 100, or 250 miles of one another.

6. The method of providing a synthetic user profile of claim 1, wherein generating the synthetic profile is done using machine learning.

7. The method of providing a synthetic user profile of claim 6, wherein the machine learning comprises a neural network.

8. The method of providing a synthetic user profile of claim 7, wherein the neural network comprises an adversarial neural network, a recurrent neural network, a convolutional neural network, or a deep learning neural network.

9. The method of providing a synthetic user profile of claim 6, wherein the machine learning is trained using real user profiles

10. The method of providing a synthetic user profile of claim 1, wherein the profile elements of the synthetic profile are consistent with one another such that it is difficult to distinguish from a real profile.

11. The method of providing a synthetic user profile of claim 1, further comprising saving the synthetic profile for reuse by a user.

12. The method of providing a synthetic user profile of claim 1, wherein the network egress point comprises a Virtual Private Network (VPN) or tunneling server.

13. The method of providing a synthetic user profile of claim 1, wherein at least one of the generating a synthetic profile and selecting a network egress are performed on a user device.

14. The method of providing a synthetic user profile of claim 1, wherein at least one of the generating a synthetic profile and selecting a network egress are performed on a server remote from a user.

15. A method of providing a synthetic user profile, comprising:
identifying external information for use with a synthetic profile; and
generating a synthetic profile comprising plurality of profile elements;
wherein the plurality of synthetic profile elements and the external information are consistent with one another.

16. The method of providing a synthetic user profile of claim 15, wherein the external information is a geographic location of a selected network egress point remote from a user of the synthetic profile, and the geographic location is consistent with the synthetic profile.

17. The method of providing a synthetic user profile of claim 15, wherein the external information comprises environmental information external to the synthetic profile.
